(19) United States
(12) Patent Application Publication
(10) Pub. No.: US 2020/0007178 A1
(43) Pub. Date: Jan. 2, 2020

(54) METHODS AND SYSTEMS FOR IMPROVING ULTRA-WIDEBAND (UWB) ELECTROMAGNETIC COMPATIBILITY (EMC) IMMUNITY

(71) Applicant: Metrom Rail, LLC, Crystal Lake, IL (US)

(72) Inventors: Kurt Alan Gunther, Woodstock, IL (US); Richard C. Carlson, Palatine, IL (US)

(21) Appl. No.: 16/454,538

(22) Filed: Jun. 27, 2019

Related U.S. Application Data
(60) Provisional application No. 62/690,641, filed on Jun. 27, 2018.

(51) Int. Cl. H04B 1/10; H04B 1/04

(52) U.S. Cl. CPC H04B 1/1036; H04B 2001/1063; H04B 1/0483

(57) ABSTRACT

Systems and methods are provided for improving ultra-wideband (UWB) electromagnetic compatibility (EMC) immunity. A system that supports communication of UWB signals may be configured for using fractional receiving bands, from an entire band allocated for the communication of the UWB signals, during reception of UWB signals. A system that supports communication of UWB signals may be configured for using split bands, from an entire band allocated for the communication of the UWB signals, during transmission of UWB signals.

### CLAIM OF PRIORITY

This patent application makes reference to, claims priority to, and claims benefit from U.S. Provisional Patent Application Ser. No. 62/690,641, filed on Jun. 27, 2018. The above identified application is hereby incorporated herein by reference in its entirety.

### BACKGROUND

Aspects of the present disclosure relate to control technologies and solutions for use in railway systems. More specifically, various implementations of the present disclosure relate to methods and systems for improving ultra-wideband (UWB) electromagnetic compatibility (EMC) immunity.

Various issues may exist with conventional approaches, if any existed, for ensuring ultra-wideband (UWB) electromagnetic compatibility (EMC) immunity. In particular, conventional methods and systems, if any existed, for ensuring ultra-wideband (UWB) electromagnetic compatibility (EMC) immunity particularly in equipment used in conjunction with and/or in support of controlling trains (e.g., in mass transit systems), may be costly, inefficient, and cumbersome.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for methods and systems for improving ultra-wideband (UWB) electromagnetic compatibility (EMC) immunity, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates an example system configured for support or use of fractional ultra-wideband (UWB) receiving bands, in accordance with the present disclosure.

FIG. 2 illustrates frequency charts for bandwidths of signals in example use scenarios of fractional ultra-wideband (UWB) receiving bands, in accordance with the present disclosure.

FIG. 3 illustrates an example alternating split band ultra-wideband (UWB) transmitter system, in accordance with the present disclosure.

FIG. 4 illustrates another example alternating split band ultra-wideband (UWB) transmitter system, in accordance with the present disclosure.

FIG. 5 illustrates another example alternating split band ultra-wideband (UWB) transmitter system, in accordance with the present disclosure.

FIG. 6 illustrates another example alternating split band ultra-wideband (UWB) transmitter system, in accordance with the present disclosure.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

Various implementations in accordance with the present disclosure are directed to communication solutions, particularly for improving electromagnetic compatibility (EMC) immunity, and specifically doing so for ultra-wideband (UWB) based communications, which may be utilized in conjunction with control technologies and solutions adaptive for use in railway systems. Improving electromagnetic compatibility (EMC) immunity may allow overcoming or at least mitigating effects of interference during wireless communications. In this regard, achieving proper operation of wireless devices subjected to severe radio frequency (RF) interference is challenging. RF interference may be divided into two main categories: out-of-band RF signals, and in-band RF signals. If the interfering RF signal frequency is outside the operating band of a radio (an out-of-band RF signal), an appropriate filter may be used to attenuate the interference, thus allowing the radio to operate normally. The filter may be a low-pass, high-pass, or band-pass filter, whichever is most appropriate for the particular application. The filter may also be implemented as a combination of different filter types, or as multiple filters in series to maximize the attenuation of the interference.

If the interfering RF signal is within the operating band of a radio (an in-band RF signal), it becomes much more difficult to ignore the interference and keep the radio operating properly since adding a filter would also attenuate the desired signal as well.

For most radio applications, it may be possible to use exclusive frequencies—e.g., through licensing with the Federal Communications Commission (FCC). With an exclusive FCC license, in-band interfering signals are not lawful because the licensed user has exclusive use of the assigned frequency within a prescribed location. This is often the case with conventional narrow-band radios, where “avoidance” (exclusive licensing) may be used to avoid interference.

Ultra-wideband (UWB) wireless communications do not enjoy the benefit of the “avoidance” approach, however. This is a natural result of the extremely wide bandwidth inherently part of UWB. Because of the wide bandwidth in UWB, one is not able to obtain an exclusive license on the frequency band which is utilized, since the frequency band (bandwidth) used for UWB may be 40,000 to 200,000 times wider than a conventional narrow-band radio. Entire band classifications would be consumed by a single license to support exclusive UWB use. This would be an unacceptable condition for a regulatory body, such as the FCC, charged with administering the radio spectrum for the public good, promoting competition, and encouraging the highest and best use of the radio spectrum.

Because UWB utilizes an extensive range of radio frequencies, the FCC requires UWB applications to use unusually low-amplitude signals. The low transmitting power is required to avoid producing interference with other operating radios in and near the UWB frequency range. Because of the low power requirement, UWB receivers will in general be more susceptible to lower amplitude interference signals when compared to conventional narrowband radios which use much higher transmitting power.

For example, the FCC allows General Mobile Radio Service (GMRS) radios operating at 462 MHz to transmit with an effective radiated power (ERP) of no more than 5 Watts (§ 95.1767c). An in-band interfering signal which has an effective power level of 50 mW (0.050 W), or 1/100 the GMRS power would likely not cause disabling interference, as the radio's co-channel rejection would likely handle that interference easily because the interference is 20 dB below the intended signal. The average ERP of an UWB signal, depending upon operating characteristics, however, may be limited by the FCC to 50 microwatts. From the UWB radio standpoint, an in-band interfering signal at 50 mW is 1,000 times higher in power than the intended UWB signal. For example, interference which is 30 dB (1,000 times) higher in amplitude than the intended signal is nearly impossible to reject.

Accordingly, implementations in accordance with the present disclosure provide methods and systems for improving ultra-wideband (UWB) electromagnetic compatibility (EMC) immunity, particularly to overcome or at least mitigate effects of radio frequency (RF) interference, including interference due to out-of-band RF signals and/or in-band RF signals.

Nonetheless, as noted above, use of UWB communication may pose unique challenges. For example, given that UWB wireless devices may be unlicensed, and use frequency bands where other devices may operate, the UWB device must be inherently equipped to cope with potential interference. While filtering may be used for out-of-band interference, in-band interference is problematic for UWB systems because there might be any number of interfering signals over the extremely wide “in-band” frequency for the UWB system.

It may be possible that a single high-powered radio signal within the UWB wireless device's operating bandwidth could result in significant interference with UWB operation. This interference can result in failed communications, severely reduced operating range, diminished data rates, or some combination of these effects. A single narrowband interference radio signal which uses 1/100,000 of the UWB operating band, if operating close enough, or if operating at a sufficiently high power, may severely impact UWB operation, and may render the UWB system unusable.

The challenge then is how to make an UWB system robust in the presence of an in-band interfering signal. Simply choosing a different frequency band for UWB operation might address a specific, known interference issue but provides no defense against future unanticipated interference sources.

In some example implementations, fractional bandwidth based solutions may be utilized for improving UWB EMC immunity. In this regard, with “fractional bandwidth” (may also be referred to “sectional bandwidth”, “partial bandwidth”, or “split bandwidth”) an entire bandwidth allocated for particular communication may be fractionated into a set of subsections (or bands), such that each band may be handled separately. Thus, instead of employing an UWB system which uses a single contiguous band of frequencies, implementations in accordance with the present disclosure may utilize an alternative approach where fractions of the entire bandwidth may be handled (e.g., received and/or processed) individually and separately, particularly by using some multiple of narrower frequency bands. From a conventional radio transmitter standpoint, these narrower frequency bands are still very wide, and thus still qualify as an UWB signal, either individually, or collectively.

The FCC defines an UWB transmitter as “an intentional radiator that, at any point in time, has a fractional bandwidth equal to or greater than 0.20 or has a UWB bandwidth equal to or greater than 500 MHz, regardless of the fractional bandwidth. (FCC § 15.503). A transmission which complies with either of these bandwidth specifications qualifies as UWB.

Fractional Bandwidth is the bandwidth of a signal divided by its center frequency. Fractional Bandwidth=Bandwidth/Center Frequency. [Another way of calculating this is 2×(Upper Frequency−Lower Frequency)/(Upper Frequency+Lower Frequency)]. For example, if the upper operating frequency is 6 GHz, and the lower operating frequency is 4 GHz, the Bandwidth is 6 GHz−4 GHz=2 GHz. The Center Frequency is (6 GHz−4 GHz)/2+4 GHz=5 GHz. The resulting Fractional Bandwidth is 2 GHz/5 GHz=0.4.

In some implementations, for example, fractional UWB receiving bands may be utilized, to address the UWB interference challenges described above may. In such implementation, the UWB signal source may transmit (intentionally radiate) an UWB signal on the entire selected UWB frequencies. The UWB signal recipient, however, may be configured to utilize multiple receivers, with each receiver being configured to use or handle only a fraction of the UWB frequencies. This effectively divides the receiver bands into a number (e.g., two or more) of fractions or portions of the entire intended UWB frequency range.

For example, suppose the UWB source transmits a signal between 4 GHz and 6.4 GHz, resulting in a 2.4 GHz bandwidth with a 5.2 GHz center frequency. This is a radiator with a fractional bandwidth of 0.462. For this fractional UWB receiving solution, the UWB receiver would provide two, three, four, or more receiver sections which utilize a portion, or fraction of the 2.4 GHz bandwidth. There are a variety of manners to implement this fractional receiver. The bandwidth of each receiver may be increased or decreased, for example, relative to the other receivers in anticipation of known or expected concentrations of interference at particular frequencies. For example, if there were two receivers, the receiver passband frequencies might be: 4.0-5.2 GHz and 5.2-6.4 GHz. If there were three receivers, the receiver passband frequencies might be: 4.0-4.8 GHz and 4.8-5.6 GHz and 5.6-6.4 GHz. If there were four receivers, the receiver passband frequencies might be: 4.0-4.6 GHz and 4.6-5.2 GHz and 5.2-5.8 GHz and 5.8 GHz-6.4 GHz.

In some example implementations, the fractional receiving bands may not be allocated equally. Rather, the allocation of the bands may be done in adaptive manner, to further enhance performance. For example, in some instances, fractional receiving bands corresponding to known or commonly occurring interference signals may be made narrower compared to the other bands, to increase the portion of the entire band that is recoverable.

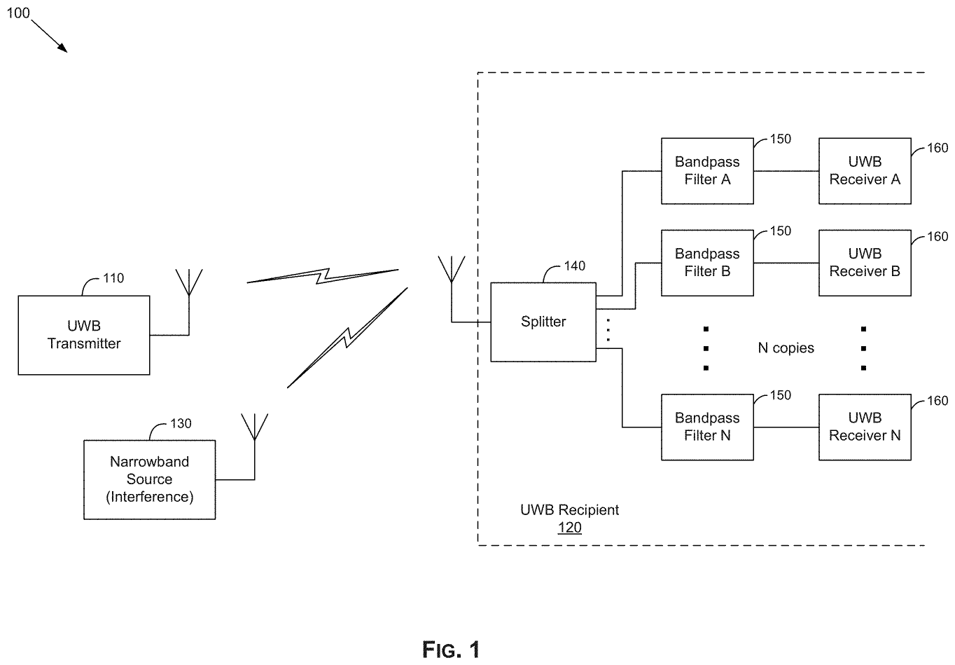

An example implementation of a fractional UWB receiving bands based arrangement in accordance with the present disclosure is described with respect to FIG. 1. It should be understood, however, that the implementation shown in FIG. 1 represents a non-limiting embodiment—i.e., that this implementation is shown to improve understanding of the proposed solution and not as the sole means of realizing this capability, and that there may be various ways for implementing and utilizing fractional UWB receiving band based solutions.

FIG. 1 illustrates an example system configured for support or use of fractional ultra-wideband (UWB) receiving bands, in accordance with the present disclosure. Shown in FIG. 1 is a system 100 that is configured for supporting use of fractional UWB receiving bands.

In the system 100, a UWB transmitter 110 may be transmitting UWB signals to a UWB recipient 120. In this regard, each of the UWB transmitter 100 and the UWB recipient 120 may comprise suitable circuitry for enabling and supporting UWB communications. Nonetheless, while system 100 is illustrated as having a transmitter and receiver, this is only for clarity and to explain the solutions proposed herein in the context of a unidirectional portion of UWB radio communications, and it should be understood that the disclosure is not so limited. Accordingly, solutions described herein may be implemented similarly in systems where both ends (e.g., devices incorporating the UWB transmitter 110 and the UWB recipient 120) support bidirectional communication, and as such incorporate transceivers rather than only a transmitter or a receiver. In other words, one or both of the UWB transmitter 110 and the UWB recipient 120 may be only a portion of a transceiver circuitry in each of the devices incorporating these elements.

In some instances, a narrowband signal source 130 may also be present, introducing interference that may affect the reception of UWB signals by the UWB recipient 120. The interference introduced by the narrowband signal source 130 may be limited to particular (small) bands within the overall bandwidth allocated for the UWB communications between the UWB transmitter 110 and the UWB recipient 120. Accordingly, incorporating a fractional UWB receiving bands based implementation in the UWB recipient 120 may mitigate the effects of the interference caused by the transmissions of the narrowband signal source 130.

For example, while the UWB transmitter 110 emits energy over the entire intended bandwidth of the UWB operating frequency band, the UWB recipient 120 may incorporate a plurality of UWB receive paths each on a portion of the operating frequency band—e.g., ‘N’ receive paths A, B, . . . , N, with N being two or more. The UWB recipient 120 may further comprise a splitter 130, which may split received UWB signals onto N corresponding copies, with each copy for one of the N receive paths. Each UWB receive path may comprise suitable circuitry for handling particular UWB band. For example, as shown in FIG. 1, each of the UWB receive paths may comprise bandpass filter 150 and a UWB receiver 160. In this regard, each independent receiver (or receive path) may be configured to unitize customized input filtering, such that an interfering signal would affect only one of the receive bands, and thus disturb only one of the fractional receivers, instead of interfering with the operation of the entire UWB recipient 120.

Accordingly, when receiving UWB signals, any interference (e.g., introduced by the narrowband signal source 130) would at most affect only one of the UWB receive paths, with the remaining paths (and thus bands being thereby) remaining unaffected. In some instances, to further enhance performance, the fraction bands may be configured such that they may be separated (e.g., by a pre-defined gap). This may be done to ensure that an interfering signal near the edge of one band (e.g., the junction between bands) would not interfere with both of the adjacent bands.

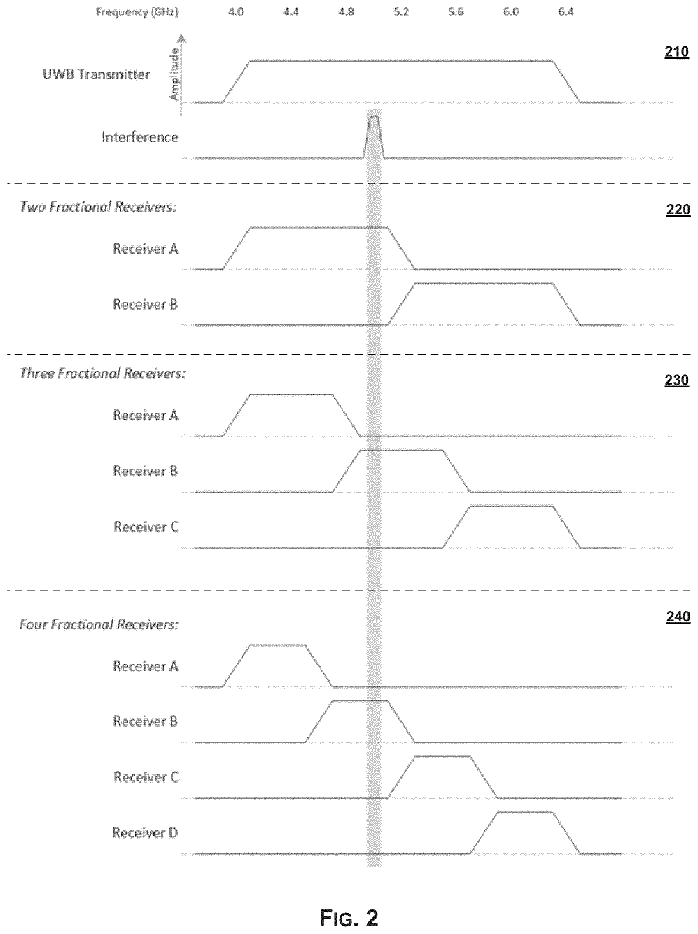

Example use scenarios corresponding to use of such fractional ultra-wideband (UWB) receiving bands based implementations are described with respect to FIG. 2.

FIG. 2 illustrates frequency charts for bandwidths of signals in example use scenarios of fractional ultra-wideband (UWB) receiving bands, in accordance with the present disclosure. Shown in FIG. 2 are frequency charts 210, 220, 230, and 240, corresponding, respectively, to a use scenario associated with each of a single receiver system (i.e., with no support for fractional UWB receiving bands), with two-receiver system (i.e., with support for two fractional receiving bands, via two corresponding independent receivers: A and B), with three-receiver system (i.e., with support for three fractional receiving bands, via three corresponding independent receivers: A, B and C), with four-receiver system (i.e., with support for four fractional receiving bands, via four corresponding independent receivers: A, B, C and D), with band receiver).

In this regard, as noted above, with fractional receiver implementations, each independent receiver may be configured to perform corresponding customized input filtering, such that an interfering signal would affect only one of the receive bands, and thus disturb only one of the fractional receivers, instead of interfering with the entire UWB receiver. For example, a narrow band interference signal at 5.0 GHz (e.g., introduced by the narrowband signal source 130 in FIG. 1) would only disturb the lowest band in the two-receiver system, only the middle band in the three-receiver system, and only of the four bands in the four-receiver system, while the other receiver band(s) would still operate successfully. Thus, in the two-receiver system, one of two bands would be unaffected by the interference. In the three-receiver system, two of three bands would be unaffected by the interference. In the four-receiver system, three of four bands would be unaffected. In other words, isolated interference would not degrade the entire UWB operation

One possible disadvantage of the “fractional receiving band” approach described herein is reduced UWB performance. For example, in the previous two-receiver example, if there is interference affecting one of the two bands, half of the transmitted energy may not be usable, resulting in a reduction in the achievable radio transmission range. To reduce this performance impact, one may increase the system complexity by adding more receivers with smaller operating bands. In the three-band example above, two thirds of the transmitted energy would be received despite interference. In the four-band example above, three quarters of the transmitted energy would be received despite interference. (Note that this description ignores other signal losses, such as that due to the splitter that couples the receiving antenna to the filters).

This segregation of the receiver operating bands for the fractional UWB receiver scheme increases the complexity of the receiver circuitry and raises device cost and power consumption. This is a result of the duplication of input stages to allow simultaneous receiver operation in different bands. The duplication of receiver functions, depending upon the implementation, may include the RF input filtering, RF input amplifier and additional signal processing circuitry. While it may be possible to consolidate all of the fractional receiving band capability into a single receiver with an analog-to-digital converter, and then performing post-processing digital filtering to accomplish the same objective, this doesn't protect against high-amplitude interference sources which are a more significant threat to UWB systems than other conventional radios, as previously noted. A single in-band high-amplitude interference source may saturate the front end RF receiver amplifier, causing a decrease in signal gain, an increase in noise figure, and other degraded performance aspects.

In some example implementations, alternating split bands-based solutions may be utilized for improving UWB EMC immunity. In this regard, instead of employing an UWB system which uses a single contiguous band of frequencies, implementations in accordance with the present disclosure may implement an alternative approach, particularly by using some multiple of narrower frequency bands. From a conventional radio transmitter standpoint, these narrower frequency bands are still very wide, and thus still qualify as an UWB signal, either individually, or collectively.

In some example implementations, alternating split bands based solutions may be utilized. In this regard, another solution for the UWB interference challenges noted above is to use a “split band” transmission approach—e.g., by alternating transmissions between multiple different bands. Accordingly, in such implementations the UWB signal source would transmit (intentionally radiate) an UWB signal alternately on one of a multiple of intended UWB frequency bands. With alternating split band based implementations, UWB signal recipient(s) are configured to handle the split band based transmissions. For example, the UWB signal recipient may utilize multiple receivers, or multiple filters with one receiver, or one receiver with adjustable filtering. Each receiver is configured to monitor one of the UWB source band, such that one of the receivers will detect the UWB transmission from either of the UWB signal sources.

In an example use scenario, an alternating split band UWB signal source alternately transmits an UWB signal from 3.25 GHz to 4.75 GHz, and next transmits an UWB signal from 6 GHz to 7.5 GHz. Both transmissions use a 1.5 GHz bandwidth, one with a 4 GHz center frequency and the other with a 6.75 GHz center frequency.

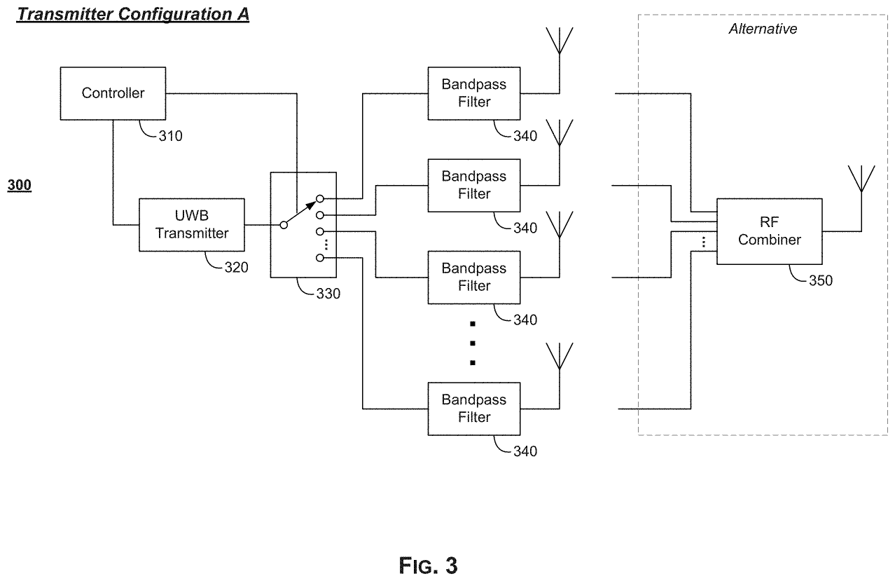

Example split band UWB transmitter implementations in accordance with the present disclosure are described with respect to FIGS. 3-6. In this regard, for the alternating split band UWB transmitter, the transmission on multiple bands may be accomplished in a variety of implementations, including a single broad frequency UWB signal generator with switchable or adjustable output filters, or by adjusting the waveshape of the UWB-generating impulse, or by employing several discrete UWB generators where the appropriate one is triggered for each selected band transmission. Likewise, a single antenna may be used to convey the UWB signal, or multiple antennas may be employed, with each one customized to the desired frequency band.

Nonetheless, it should be understood that each of the implementations illustrated in FIGS. 3-6 represents a non-limiting embodiment, and that there may be various others ways for implementing and utilizing split band based UWB transmission based solutions. Each receiving path in an implementation incorporating the alternating split band approach may have customized input filtering. In this manner, an interfering signal would potentially only disturb one of the receiver bands, instead of the entire UWB receiver. Further, while FIGS. 3-6 only show a transmitter portion, the disclosure is not so limited, and in some implementations, a similar variation of receiver configurations may be employed.

FIG. 3 illustrates an example alternating split band ultra-wideband (UWB) transmitter system, in accordance with the present disclosure. Shown in FIG. 3 is a transmitter system 300 that is configured for supporting use of split band UWB transmission.

The transmitter system 300 may comprise suitable circuitry for enabling and supporting UWB transmissions, and particularly for doing so using alternating split bands—that is, with UWB signals may be transmitted on different bands within the entire allocated band, with the transmitted signals alternating among these split bands.

For example, as shown in the example implementation illustrated in FIG. 3, the transmitter system 300 may comprise a controller 310, a UWB transmitter 320, and a switch 330. The controller 310 comprises suitable circuitry for controlling the transmitter system 300, and particularly UWB transmission related functions, such as by generating and/or providing data and control signals for driving and/or otherwise controlling operations of other components of the transmitter system 300. The UWB transmitter 320 comprises suitable circuitry for generating and/or processing UWB signals, including embedding data carried by these signals. In this regard, the UWB transmitter 320 may be configured for generating signals over single broad frequency UWB band. The switch 330 comprises suitable circuitry for switching among a plurality of UWB transmit paths, to direct signals generated by the UWB transmitter 320 to the selected UWB transmit path.

Each UWB transmit path may comprise suitable circuitry for handling transmission of UWB signal over a corresponding plurality of UWB split bands. For example, as shown in FIG. 3, each of the UWB transmit paths may comprise a bandpass filter 340. In this regard, each UWB transmit path may be configured to unitize customized output filtering, via the corresponding bandpass filter 340, to ensure that only the assigned split band is utilized for UWB transmission. The outputs of the bandpass filters 340 may then be transmitted individually via corresponding antenna. In an alternative implementation, the outputs of the UWB transmit paths may be combined, via an RF combiner 350 to utilize a common antenna.

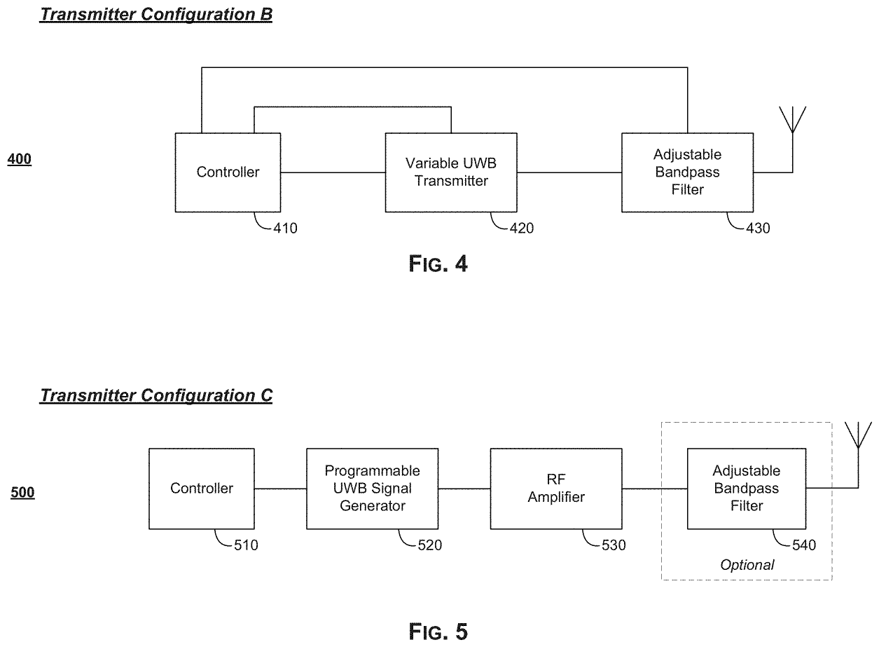

FIG. 4 illustrates another example alternating split band ultra-wideband (UWB) transmitter system, in accordance with the present disclosure. Shown in FIG. 4 is a transmitter system 400 that is configured for supporting use of split band UWB transmission.

The transmitter system 400 may be similar to the transmitter system 300—being similarly configured for supporting alternating split band UWB transmissions, and as such similarly comprising suitable circuitry for enabling and supporting UWB transmissions, and particularly for doing so using alternating split bands. The transmitter system 400 may incorporate a different design, however.

In particular, the transmitter system 400 may be configured for supporting adaptively adjusting the UWB signals—e.g., by adjusting the waveform of the UWB-generating impulses during the UWB signal generation phase, based on each of the split bands—i.e., match the UWB signal generation to the particular selected band from the split bands as the transmission alternates among these split bands.

For example, as shown in the example implementation illustrated in FIG. 4, the transmitter system 400 may comprise a controller 410, a variable UWB transmitter 420, and an adjustable bandpass filter 430. The controller 410 comprises suitable circuitry for controlling the transmitter system 400, and particularly UWB transmission related functions, such as by generating and/or providing data and control signals for driving and/or otherwise controlling operations of other components of the transmitter system 400.

The variable UWB transmitter 420 comprises suitable circuitry for generating and/or processing UWB signals, including embedding thereon data carried by these signals. Further, the variable UWB transmitter 420 may comprise suitable circuitry for adaptively adjusting the UWB signals for transmission, to match the selected split band at any given point. Similarly, the adjustable bandpass filter 430 may comprise suitable circuitry for providing bandpass filtering functions in adaptive manner—e.g., to match the selected split band at any given point.

Accordingly, as the transmitter system 400 alternates among the split bands, the variable UWB transmitter 420 and the adjustable bandpass filter 430 are (re-)configured to ensure that the transmitted UWB signals match the selected split band—e.g., by adjusting the UWB signals in the variable UWB transmitter 420, and the bandpass filtering functions in the adjustable bandpass filter 430.

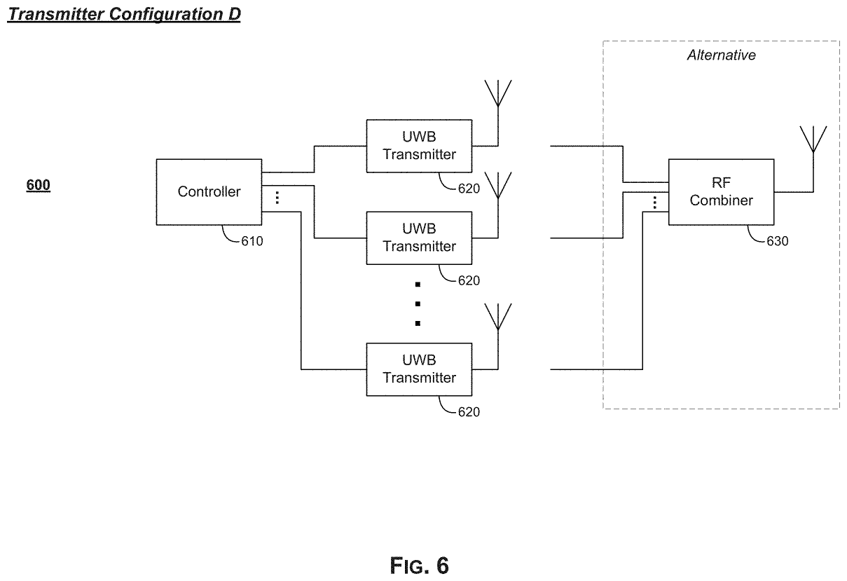

FIG. 5 illustrates another example alternating split band ultra-wideband (UWB) transmitter system, in accordance with the present disclosure. Shown in FIG. 5 is a transmitter system 500 that is configured for supporting use of split band UWB transmission.

The transmitter system 500 may be similar to the transmitter system 400—being similarly configured for supporting alternating split band UWB transmissions, and as such similarly comprising suitable circuitry for enabling and supporting UWB transmissions, and particularly for doing so using alternating split bands, and similarly being configured for supporting adaptively adjusting the UWB signals generated in the system to match a particular band—namely, one of the split bands used during alternating split band ultra-wideband UWB transmissions. The transmitter system 500 may incorporate a different design, however.

In particular, as shown in the example implementation illustrated in FIG. 5, the transmitter system 500 may comprise a controller 510, a programmable UWB signal generator 520, a radio frequency (RF) amplifier 530, and (optionally) an adjustable bandpass filter 540. The controller 510 comprises suitable circuitry for controlling the transmitter system 500, and particularly UWB transmission related functions, such as by generating and/or providing data and control signals for driving and/or otherwise controlling operations of other components of the transmitter system 500.

The programmable UWB signal generator 520 comprises suitable circuitry for generating and/or processing UWB signals, including embedding thereon data carried by these signals. Further, the programmable UWB signal generator 520 may comprise suitable circuitry for adaptively adjusting the UWB signals—e.g., by adjusting the waveform of the UWB-generating impulses during the UWB signal generation phase, such as to match the selected split band at any given point. The RF amplifier 530 may comprise suitable circuitry for amplifying signals generated via the programmable UWB signal generator 520. The adjustable bandpass filter 540 may comprise suitable circuitry for providing bandpass filtering functions in adaptive manner—e.g., to match the selected split band at any given point.

Accordingly, as the transmitter system 500 alternates among the split bands, the programmable UWB signal generator 520, the RF amplifier 530, and the adjustable bandpass filter 540 may be (re-)configured to ensure that the transmitted UWB signals match the selected split band.

FIG. 6 illustrates another example alternating split band ultra-wideband (UWB) transmitter system, in accordance with the present disclosure. Shown in FIG. 6 is a transmitter system 600 that is configured for supporting use of split band UWB transmission.

The transmitter system 600 may be similar to the transmitter system 300—being similarly configured for supporting alternating split band UWB transmissions, and as such similarly comprising suitable circuitry for enabling and supporting UWB transmissions, and particularly for doing so using alternating split bands. The transmitter system 600 may incorporate a different design, however.

In particular, the transmitter system 600 may incorporate a design based on employing several discrete UWB generators, which configured for generating UWB signals for particular band—e.g., one of the split bands used during the alternating split band transmissions.

For example, as shown in the example implementation illustrated in FIG. 6, the transmitter system 600 may comprise a controller 610 and a plurality of UWB transmit paths. The controller 610 comprises suitable circuitry for controlling the transmitter system 600, and particularly UWB transmission related functions, such as by generating and/or providing data and control signals for driving and/or otherwise controlling operations of other components of the transmitter system 600. Each UWB transmit path may comprise suitable circuitry for handling transmission of UWB signal over corresponding of a plurality of UWB split bands.

In particular, each of the UWB transmit path comprises a corresponding UWB transmitter 620 that comprises suitable circuitry for generating UWB signals based on particular corresponding band. In this regard, each of the UWB transmitters 620 may be configured for generating UWB signals corresponding to one of the split bands used in the transmitter system 600 during alternating UWB split band transmissions, with each of the UWB transmitters 620 (and the UWB transmit path that comprises the UWB transmitter 620 as a whole) being triggered (e.g., activated and used) for each selected band transmission based on the corresponding assigned band.

The outputs of the UWB transmit paths may then be transmitted individually via corresponding antenna. In an alternative implementation, the outputs of the UWB transmit paths may be combined, via an RF combiner 630 to utilize a common antenna.

The advantage of the alternating split band approach is that the entire allowable UWB energy (complying with the regulated transmission limit) may be used for each transmission. This maximizes the transmission distance when compared to the “fractional receiving band” approach detailed earlier.

One possible disadvantage of the “alternating split band” approach is that throughput is decreased in the event of disruptive interference on one band, since some of the transmission attempts may be unsuccessful. The reduced throughput characteristic may be virtually eliminated in environments where the interference frequency is consistent. With interference occurring in an individual band, the receiver may send a message through its return communications path (not shown) to instruct the transmitter that the interfered band may be skipped continuously, allowing bands without interference to be utilized exclusively.

Another possible disadvantage is that “alternating split band” approach may also add complexity to the receiver circuitry. This approach may also increase power consumption because it may require additional input stages and/or it may require duplication of receiver functions such as the RF input filter, RF input amplifier, the analog to digital converter(s), and additional signal processing.

In some example implementations, switchable notch filtering based solutions may be utilized for improving UWB EMC immunity. In this regard, in the event the interfering sources are known, fixed frequencies, an additional solution for the UWB interference challenge is to use notch filters in the UWB receiver(s). The width of the notch filters would be chosen to substantially reduce the gain of the UWB recipient input amplifier only over the narrow range of interfering frequencies. For versatility, this notch filter may be configured to be switchable. This would allow the notch filter to be enabled or disabled as the particular application environment requires.

In some example implementations, programmable notch filtering based solutions may be utilized for improving UWB EMC immunity. In this regard, in the event the interfering source frequencies are stable, but vary by environment, another solution for the UWB interference challenge is to use programmable frequency notch filters in the UWB receiver(s). The specific frequency of the notch filter(s) would be chosen according to the individual environment. The width of the notch filters would be chosen to substantially reduce the gain of the UWB recipient input amplifier only over the narrow range of expected interfering frequencies.

An example system for improving (EMC) immunity during ultra-wideband (UWB) communications, in accordance with the present disclosure, may comprise one or more antennas for communicating wireless signals; and one or more circuits for handling reception of signals via the one or more antennas, the signals may comprise ultra-wideband (UWB) based signals. The one or more circuits may be configured for using fractional receiving bands during reception of the UWB signals, and the use of fractional receiving bands may comprise utilizing a plurality of bands from an entire band allocated for the reception of the UWB signals.

In an example implementation, the one or more circuits may be arranged onto a plurality of receive paths, with each of the plurality of receive paths configured for handling a corresponding one of the plurality of bands.

In an example implementation, each of the plurality of receive paths may comprise a filter configured for filtering signals of the corresponding one of the plurality of bands. The filter may comprise a bandpass filter.

In an example implementation, each of the plurality of receive paths may comprise a UWB receiver configured for applying UWB receive functions to signals of the corresponding one of the plurality of bands.

In an example implementation, the one or more circuits may comprise a splitter for splitting signals received via the one or more antenna onto the plurality of receive paths.

An example system for improving (EMC) immunity during ultra-wideband (UWB) communications, in accordance with the present disclosure, may comprise one or more antennas for communicating wireless signals; and one or more circuits for handling transmission of signals via the one or more antennas, the signals may comprise ultra-wideband (UWB) based signals. The one or more circuits may be configured for using alternating split bands during transmission of the UWB signals, and alternating split bands may comprise alternating among a plurality of bands from an entire band allocated for the transmission of the UWB signals.

In an example implementation, the one or more circuits may comprise a controller configured for controlling the transmission of the UWB signals.

In an example implementation, the one or more circuits may be arranged onto a plurality of transmit paths, with each of the plurality of receive paths handling a corresponding one of the plurality of bands.

In an example implementation, the one or more circuits may comprise a single UWB transmitter configured for applying UWB transmit functions to signals across the entire band allocated for the transmission of the UWB signals.

In an example implementation, each of the plurality of transmit paths may comprise an adjustable filter configured for filtering signals based on one of the plurality of bands.

In an example implementation, each of the plurality of transmit paths may comprise a UWB transmitter configured for applying UWB transmit functions to signals corresponding to one of the plurality of bands.

In an example implementation, the one or more circuits may comprise a combiner configured for combining outputs from the plurality of transmit paths for transmittal via the one or more antennas.

In an example implementation, the one or more circuits may be arranged onto single transmission path configured for alternating through the plurality of bands during the transmission of UWB signals.

In an example implementation, the single transmission path may comprise a variable UWB transmitter configured for varying processing of UWB signals based on each of the plurality of bands when alternating through the plurality of bands during the transmission of UWB signals.

In an example implementation, the single transmission path may comprise a programmable UWB signal generator configured for adaptively generating UWB signals based on each of the plurality of bands when alternating through the plurality of bands during the transmission of UWB signals.

In an example implementation, the single transmission path may comprise a radio frequency (RF) amplifier.

In an example implementation, the single transmission path may comprise an adjustable filter configured for filtering signals for each of the plurality of bands when alternating through the plurality of bands during the transmission of UWB signals. The filter may comprise an adjustable bandpass filter.

Aspects of the techniques described herein may be implemented in digital electronic circuitry, computer software, firmware, or hardware, including the structures disclosed herein and their structural equivalents, or in various combinations. Aspects of the techniques described herein may be implemented using a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Each of the computer programs may have, for example, one or more sets of program instructions residing on or encoded in the non-transitory computer-readable storage medium for execution by, or to control the operation of, one or more processors of the machine or the computer. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processors.

A non-transitory computer-readable medium may be, or be included in, a non-transitory computer-readable storage device, a non-transitory computer-readable storage substrate, a random or serial access memory array or device, various combinations thereof. Moreover, while a non-transitory computer-readable medium may or may not be a propagated signal, a non-transitory computer-readable medium may be a source or destination of program instructions encoded in an artificially-generated propagated signal. The non-transitory computer-readable medium may also be, or be included in, one or more separate physical components or media (for example, CDs, disks, or other storage devices).

Certain techniques described in this specification may be implemented as operations performed by one or more processors on data stored on one or more computer-readable mediums or received from other sources. The term “processor” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processor may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processors located at one site or distributed across multiple sites connected by a network.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Where the term “comprising” appears, it is contemplated that the terms “consisting essentially of” or “consisting of” could be used in its place to describe certain embodiments of the present technology. Further, all references cited herein are incorporated in their entireties.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system comprising:
one or more antennas for communicating wireless signals; and
one or more circuits for handling reception of signals via the one or more antennas, the signals comprising ultra-wideband (UWB) based signals,
wherein:
the one or more circuits are configured for using fractional receiving bands during reception of the UWB signals, and
the use of fractional receiving bands comprises utilizing a plurality of bands from an entire band allocated for the reception of the UWB signals.

2. The system of claim 1, wherein the one or more circuits are arranged onto a plurality of receive paths, with each of the plurality of receive paths configured for handling a corresponding one of the plurality of bands.

3. The system of claim 2, wherein each of the plurality of receive paths comprises a filter configured for filtering signals of the corresponding one of the plurality of bands.

4. The system of claim 3, wherein the filter comprises a bandpass filter.

5. The system of claim 2, wherein each of the plurality of receive paths comprises a UWB receiver configured for applying UWB receive functions to signals of the corresponding one of the plurality of bands.

6. The system of claim 1, wherein the one or more circuits comprise a splitter for splitting signals received via the one or more antenna onto the plurality of receive paths.

7. A system comprising:
one or more antennas for communicating wireless signals; and
one or more circuits for handling transmission of signals via the one or more antennas, the signals comprising ultra-wideband (UWB) based signals,
wherein:
the one or more circuits are configured for using alternating split bands during transmission of the UWB signals, and
alternating split bands comprising alternating among a plurality of bands from an entire band allocated for the transmission of the UWB signals.

8. The system of claim 7, wherein the one or more circuits comprise a controller configured for controlling the transmission of the UWB signals.

9. The system of claim 7, wherein the one or more circuits are arranged onto a plurality of transmit paths, with each of the plurality of receive paths handling a corresponding one of the plurality of bands.

10. The system of claim 9, wherein the one or more circuits comprise a single UWB transmitter configured for applying UWB transmit functions to signals across the entire band allocated for the transmission of the UWB signals.

11. The system of claim 10, wherein each of the plurality of transmit paths comprises an adjustable filter configured for filtering signals based on one of the plurality of bands.

12. The system of claim 9, wherein each of the plurality of transmit paths comprises a UWB transmitter configured for applying UWB transmit functions to signals corresponding to one of the plurality of bands.

13. The system of claim 9, wherein the one or more circuits comprise a combiner configured for combining outputs from the plurality of transmit paths for transmittal via the one or more antennas.

14. The system of claim 7, wherein the one or more circuits are arranged onto single transmission path configured for alternating through the plurality of bands during the transmission of UWB signals.

15. The system of claim 14, wherein the single transmission path comprises a variable UWB transmitter configured for varying processing of UWB signals based on each of the plurality of bands when alternating through the plurality of bands during the transmission of UWB signals.

16. The system of claim 14, wherein the single transmission path comprises a programmable UWB signal generator configured for adaptively generating UWB signals based on each of the plurality of bands when alternating through the plurality of bands during the transmission of UWB signals.

17. The system of claim 14, wherein the single transmission path comprises a radio frequency (RF) amplifier.

18. The system of claim 14, wherein the single transmission path comprises an adjustable filter configured for filtering signals for each of the plurality of bands when alternating through the plurality of bands during the transmission of UWB signals.

19. The system of claim 18, wherein the filter comprises an adjustable bandpass filter.
